(19) United States
(12) Patent Application Publication
(10) Pub. No.: US 2026/0149471 A1
(43) Pub. Date: May 28, 2026

(54) UWB COMMUNICATION METHOD, UWB DEVICE, AND MEDIUM

(71) Applicant: Calterah Semiconductor Technology (Shanghai) Co., Ltd., Shanghai (CN)

(72) Inventors: Hua MEI, Shanghai (CN); Daiqin ZHANG, Shanghai (CN)

(21) Appl. No.: 19/449,684

(22) Filed: Jan. 15, 2026

Related U.S. Application Data
(63) Continuation-in-part of application No. PCT/CN2025/081609, filed on Mar. 10, 2025.

(30) Foreign Application Priority Data
May 27, 2024 (CN) 2024106703396

(51) Int. Cl. H04B 1/00; H04L 5/00

(52) U.S. Cl. CPC H04B 1/0092; H04L 5/0053

(57) ABSTRACT

A UWB communication method, UWB device, and medium, wherein the method includes: determining a target preamble from a plurality of preset preambles based on status information of detected preambles in a current environment; the status information is used to mark an occupied condition of the detected preamble; and performing UWB communication using the target preamble to reduce a probability that the target preamble is interfered.

### CROSS-REFERENCE TO RELATED APPLICATIONS

The present application is a continuation-in-part of International Application PCT/CN2025/081609 having an international filing date of March 10, 2025, which claims priority to Chinese Patent Application No. 202410670339.6 filed on May 27, 2024 and entitled “UWB Communication Method, UWB Device and Medium”. The entire contents of the above-identified applications are incorporated herein by reference.

### TECHNICAL FIELD

Embodiments of the present disclosure relate to, but are not limited to, the field of UWB communication technologies, and particularly to a UWB communication method, a UWB device, and a medium.

### BACKGROUND

UWB (Ultra Wide Band) technology is a wireless carrier communication technology that uses extremely wide frequency bandwidth. Because of its unique advantages such as wide bandwidth, high-precision positioning capability and low power consumption, UWB technology is widely used in Internet of Things, indoor positioning, wireless data transmission, radar and other fields.

According to existing UWB communication protocols, when there is a scenario in which multiple UWB devices perform communication tasks, mutual interference may occur, thus affecting communication quality of the UWB devices.

### SUMMARY

The following is a summary of subject matter described in detail herein. This summary is not intended to limit the scope of protection of the claims.

In a first aspect, an embodiment of the present disclosure provides a UWB communication method, including: determining a target preamble from a plurality of preset preambles based on status information of detected preambles in a current environment; each piece of status information is configured to mark an occupied condition of a detected preamble; and performing UWB communication using the target preamble to reduce a probability that the target preamble is interfered.

In a second aspect, an embodiment of the present disclosure provides a UWB device, including: a first transceiving circuit configured to transceive a UWB signal for UWB communication; and receive a signal in a current environment for at least on period of time when a UWB communication task is not performed; a signal processor coupled to the first transceiving circuit and configured to detect status information of a preamble in the received signal; a controller coupled to the signal processor and the first transceiving circuit, and configured to control the first transceiving circuit and the signal processor to perform the UWB communication method in the above embodiment to perform UWB communication.

In a third aspect, an embodiment of the present disclosure provides a non-transitory computer storage medium, on which a computer program is stored, wherein the computer program, when executed by a controller, causes the controller to implement the UWB communication method of the above embodiment.

After the drawings and detailed description are read and understood, other aspects can be understood.

### BRIEF DESCRIPTION OF THE DRAWINGS

Accompanying drawings are used for providing understanding of technical solutions of the present disclosure, and form a part of the specification. They are used for explaining the technical solutions of the present disclosure together with embodiments of the present disclosure, but do not form a limitation on the technical solutions of the present disclosure.

FIG. 1 is a flowchart of an embodiment of a UWB communication method according to the present disclosure.

FIG. 2 is a flowchart of determining a target preamble in one embodiment of a UWB communication method according to the present disclosure.

FIG. 3 is a flowchart of periodic detection in one embodiment of a UWB communication method according to the present disclosure.

FIG. 4 is a flowchart of another embodiment of a UWB communication method according to the present disclosure.

FIG. 5 is a schematic diagram of a structure of an embodiment of a UWB device according to the present disclosure.

FIG. 6 is another schematic diagram of a structure of a UWB device according to the present disclosure.

### DETAILED DESCRIPTION

Embodiments of the present disclosure will be described in detail with reference to the accompanying drawings. The embodiments in the present disclosure and the features in the embodiments may be combined with each other arbitrarily if there is no conflict.

An implementation of the present disclosure is not necessarily limited to dimensions shown in the drawings, and the shapes and sizes of the components in the drawings do not reflect actual scales. Further, the drawings schematically illustrate ideal examples, but implementations of the present disclosure are not limited to shapes or values shown in the drawings.

Ordinal numerals such as “first” and “second” in the present disclosure are provided to avoid confusion between constituent elements, but do not indicate any order, quantity or importance.

Multiple embodiments are described herein, but the description is exemplary rather than restrictive, and to those of ordinary skills in the art, there may be more embodiments and implementation solutions within the scope of the embodiments described herein. Although many possible combinations of features are shown in the accompanying drawings and discussed in specific implementations, many other combinations of the disclosed features are also possible. Unless expressly limited, any feature or element of any embodiment may be used in combination with, or may replace, any other feature or element in any other embodiment.

Further, when describing representative embodiments, a method and process may have been presented as steps in a particular sequence in the specification. However, to an extent that the method or process does not depend on the particular sequence of the steps described in the present disclosure, the method or process should not be limited to the steps in the particular sequence. Those of ordinary skills in the art will understand that other sequences of steps may also be possible. Therefore, the particular sequence of the steps illustrated in the specification should not be interpreted as a limitation on claims. In addition, the claims directed to the method and process should not be limited to performing the acts according to the written sequence. Those skilled in the art may easily understand that these sequences may be changed, and the changed sequences are still maintained in the essence and scope of the embodiments of the present disclosure.

UWB communication is mainly used for ranging interaction between two UWB devices. The ranging interaction includes two UWB devices implementing time synchronization using a preamble; and the two UWB devices using a UWB signal for ranging transceiving. Thus, the distance between the two UWB devices is calculated by using the timestamps of the interactive transceiving of the UWB signal.

Herein, the preamble used to achieve time synchronization usually consists of a series of pulse sequences, which may be composed of pulses representing-1, 0 and +1. The preamble can be expanded into preamble symbols, which are used to form the SYNC (synchronization) field part of the synchronization header to provide necessary synchronization information. The preamble is located at the forefront of the data packet, and the UWB device identifies the starting point of the data packet by matching the preamble.

In order to facilitate UWB communication, the two UWB devices are configured as an initiator and a responder respectively. Both the initiator and the responder may be provided with a transceiving circuit for transmitting and receiving UWB signals. In an example of ranging, after clock synchronization, according to the transceiving agreement, the initiator transmits a first UWB signal; the responder responds to the first UWB signal and transmits a second UWB signal; the initiator records a timestamp for transmitting the first UWB signal and a timestamp for receiving the second UWB signal, and sends them to the responder for the responder to calculate the distance between the two devices.

In some application scenarios such as parking lots, there may be a situation where a large number of car keys and vehicle UWB devices may have intensive ranging communication within a same period of time, which may lead to preamble interference between different groups of UWB devices, thus affecting their respective communication quality. For this reason, in some technologies, when a group of UWB devices are interfered by other UWB devices, they usually adopt a backoff or retransmission strategy to wait for an appropriate opportunity (for example, when the channel is idle) to send the UWB signal again. However, this method takes a long time, resulting in poor timeliness of data.

Embodiments of the present disclosure provide a UWB communication method. The method is mainly performed by a UWB device, which may be an initiator or a responder in the above example, and for the role of the initiator or responder that it is configured to, one of a plurality of preset preambles can be selected as a target preamble for UWB communication with a peer device. Here, the UWB device selects the target preamble on the basis that comes from ways mentioned by performing following examples when the UWB communication is not performed. The way in which the UWB device does not perform UWB communication includes, but is not limited to, at least one of the following: the UWB device does not establish a ranging session with other UWB devices; the UWB device has not transmitted/received any signal for UWB communication; some circuits in UWB devices, such as transmitters, are in a low power consumption state.

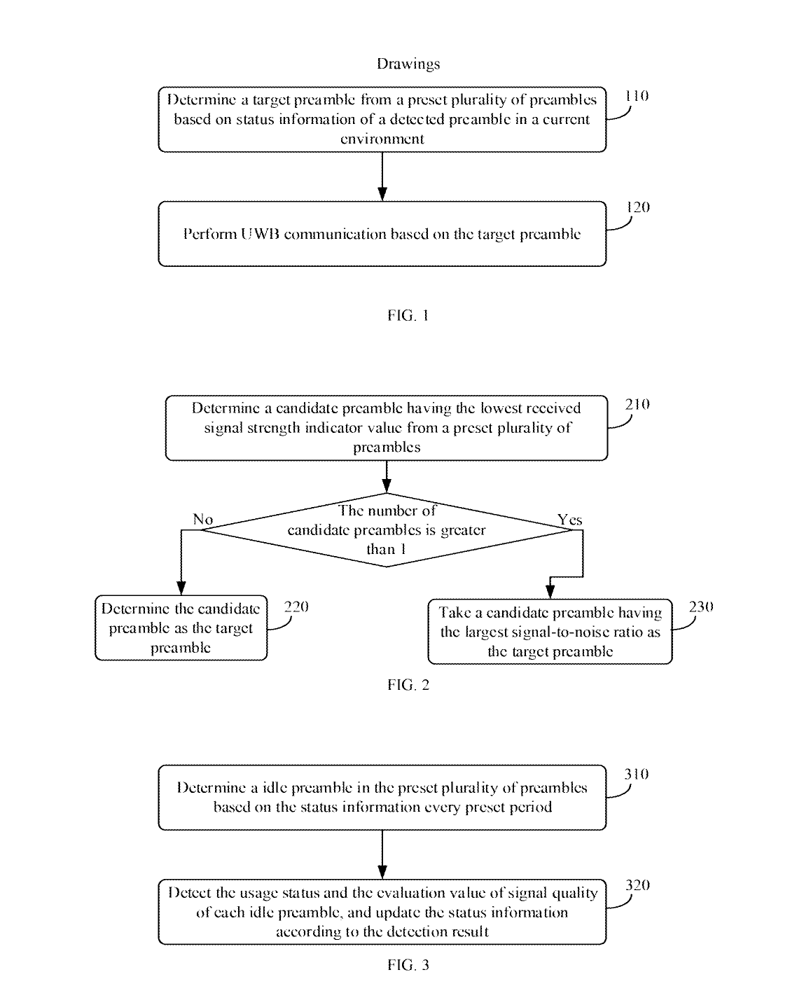

As shown in FIG. 1, the method includes the following steps 110 and 120.

Step 110: determining a target preamble from a plurality of preset preambles based on status information of detected preambles in a current environment.

Herein, the status information is used to mark the occupied condition of the detected preamble. In this embodiment, the status information is quantifiable information to characterize the occupied condition of each of a plurality of preset preambles. The occupied condition may be the possibility that each preamble obtained using the detection mechanism is available for UWB communication. For example, the occupied condition may indicate whether the preamble has been used as one of the channel parameters by other UWB devices and/or the quality of a signal using the preamble.

In some examples, the status information may include a usage status of the preamble. If the usage status is idle, it indicates that no UWB device in the current environment uses the preamble for communication. If the usage status is occupied, it indicates that there is a UWB device in the current environment using this preamble for communication.

In this embodiment, the UWB device may preset a plurality of preambles, and traverse a digital sequence of the received UWB signal and perform cross-correlation calculation with each preamble to detect whether the preamble is occupied. If a preamble can be detected, it indicates that the preamble has been occupied, that is, the detected preamble is in an occupied state. On the contrary, if the corresponding preamble is not detected to be occupied, it means that the preamble is in an idle state. Optionally, the detection duration may be limited, and if timeout (i.e., exceeding the detection duration) occurs and one or more preambles are not detected, it indicates that the corresponding preamble is not occupied, that is, the detected preamble is in an idle state.

In another example, the status information may also characterize an occupied condition of the preamble by using a quality of the UWB signal of the preamble. The signal quality may include one or more of a Received Signal Strength Indicator (RSSI), a signal-to-noise ratio, and other parameters characterizing signal quality.

The UWB device can calculate channel quality such as signal-to-noise ratio by counting signal energy of the preamble and noise floor energy of the channel. Thereafter, the UWB device may convert the detected preamble and its signal quality into status information. Herein, the UWB device can directly record idle or occupied symbols and the signal qualities into status information.

As an example, the UWB device can detect all preambles before starting a communication task, and the status information obtained at this time includes information of all preambles in the current environment, so that a target preamble can be selected from all the preambles, which is conducive to reducing a probability of interference during target UWB communication. Or, in order to reduce time and resources required for scanning all channels, some preambles can be selected from the preambles in the current environment as detection objects in advance, that is, the UWB device may only detect some preambles in the current environment, on the one hand, consumption of detecting the preambles can be reduced, on the other hand, a filtering range of the target preamble can be narrowed, and the target preamble can be determined more quickly. As an example, a frequency of use of each preamble in the current environment may be recorded in advance, and then preambles with lower frequencies of usage may be selected as the detection objects.

The UWB device may also use a strategy of filtering the target preamble to convert quantized data described above into numerical values that can be sorted. For example, the status information may characterize the occupied condition of a preamble from two aspects, i.e., usage status and signal quality, and the UWB device may filter and sort a plurality of preambles from the two aspects to determine a target preamble. For example, the UWB device may first filter or sort a plurality of preset preambles according to the usage status, and when there is an idle preamble, any one idle preamble can be selected as the target preamble. When there is no idle preamble, the plurality of preambles may be sorted according to signal quality to select the target preamble. For another example, the UWB device uses a policy algorithm to convert the quantized data into a numerical value that can be sorted, and selects a target preamble.

The UWB device may determine a target preamble from a plurality of preset preambles according to the status information. Herein, a scheme of filtering the available preamble will be described separately later.

Step 120: performing UWB communication using a target preamble to reduce a probability that the target preamble is interfered.

Here, the UWB device sends the target preamble to a peer device to achieve clock synchronization and help complete ranging interaction.

In some optional embodiments, the above step 120 may further include sending the target preamble to the peer device to enable the peer device to perform time synchronization.

With the determined target preamble, the UWB device can be configured to perform communication tasks including ranging, positioning, and the like. Herein, the UWB device and the peer device use a UWB pulse signal to transmit the target preamble to perform communication tasks including ranging, positioning and the like. The peer device refers to a UWB device that interacts with the aforementioned UWB device. For example, when the UWB device is an initiator, the peer device is a responder, and when the UWB device is a responder, the peer device is an initiator.

In one example, the UWB device transmits channel parameters including the target preamble to the peer device so that operations such as clock synchronization, ranging initiation, and response can be quickly completed using the target preamble during subsequent UWB ranging interaction, thereby reducing the probability that the preamble is interfered by other UWB devices.

In yet another example, without the necessary execution timing with respective to step 110, the UWB device and the peer device may first communicate using other preambles as channel parameters. When the target preamble is selected by performing step 110, the UWB device may send the target preamble to the peer device to instruct the peer device to update the adopted channel parameters, and use new channel parameters to perform UWB communication, thereby improving the communication quality between the UWB device and the peer device. For example, after the target preamble is determined, the UWB device and the peer device may replace the adopted preamble with the target preamble after a preset number of time units, and the time unit may be at least one of a block, a round, and a time slot.

In the above example, the UWB device may be a responder of the UWB communication system, and after the UWB device determines the target preamble through step 110, the UWB device may transmit the target preamble to the initiator of the UWB communication system through Bluetooth or a UWB signal, etc., and thereby making an agreement to use the target preamble as one of the signal parameters, so that both parties can perform UWB communication using the target preamble subsequently. Or, the UWB device may also be an initiator of the UWB communication system, and after the UWB device determines the target preamble through step 110, the UWB device may send the target preamble to the responder of the UWB communication system, thereby making an agreement that both parties use the target preamble as one of the signal parameters, so that both parties can perform UWB communication using the target preamble.

In the communication method of this embodiment, the status information is used to characterize an occupied condition of a preset preamble among a plurality of preset preambles in the current environment, and the target preamble is determined according to the status information, so as to reduce a probability that the target preamble is interfered, so that when UWB communication is performed using the target preamble, the risk of interference can be reduced, and the communication quality of the UWB can be improved.

In order to more accurately and efficiently determine the target preamble with the best occupied condition, a filtering priority can be set according to contents included in the status information. Examples of the way of filtering the priority include, but are not limited to: configuring multiple sorting of measured parameter types and parameter values thereof; calculating a numerical value for sorting using a weighting algorithm for each parameter type; or multiple sorting configured in combination with status information and other filtering data or numerical values for sorting, etc. Other examples of filtering data include: a communication distance between two UWB devices, etc. For example, the priority of the status information may be set in accordance with at least one of channel idleness, signal quality, and communication distance.

In one example, the priority may be determined according to the status information. For example, the status information may include usage status information and signal quality of the preamble, and the UWB device may preferentially select the target preamble according to the usage status information: in the case where there is an idle preamble in the status information, any one idle preamble is determined as the target preamble; in the case where there is no idle preamble in the status information, a target preamble is determined from a plurality of preambles based on signal quality. For example, a preamble having a high signal quality is determined as the target preamble from a plurality of preset preambles.

For example, the signal quality may represent radio environmental interference within a range in which the UWB device can communicate. The UWB device may select the target preamble using the flow shown in FIG. 2. As shown in FIG. 2, the flow includes the following steps.

In step 210: determining a candidate preamble having the lowest received signal strength indicator value from a plurality of preset preambles.

Step 220: for a case where the number of candidate preamble is 1, determining the candidate preamble as the target preamble.

Step 230: for a case where the number of candidate preambles is greater than 1, taking one candidate preamble having a largest signal-to-noise ratio as the target preamble.

In this example, if there is no idle preamble in the current environment, a preamble having a lower probability of being interfered can be selected as a candidate preamble according to the received signal strength indicator value first, and if there are a plurality of candidate preambles having the same probability of being interfered, a candidate preamble having the strongest anti-interference ability can be selected as a target preamble according to the signal-to-noise ratio, and the target preamble can be selected more accurately to reduce the probability of being interfered during UWB communication.

In another example, the priority may also be determined according to other parameters not limited to the status information, such as communication distance. The communication distance here refers to a relative distance between the UWB device and the peer device. For example, the UWB device may also detect the status of the used preamble during ranging interaction with the peer device, so as to timely adjust the preamble used for subsequent ranging interaction when there is a preamble collision. When the communication distance is large, a preamble with a longer length can be preferentially selected as the target preamble, and when the communication distance is small, a preamble with a shorter length can be preferentially selected as the target preamble. Or, the UWB device may preferentially select an idle preamble as the target preamble according to the usage status, and may preferentially select a preamble having a longer length as the target preamble for a plurality of idle preambles when the communication distance is large, and when the communication distance is small, a preamble with a shorter length can be preferentially selected as the target preamble. Or, the priority from high to low is channel idleness, signal quality, and communication distance, and when there is no idle preamble and there are a plurality of preambles having the same signal quality, if the communication distance is large, a preamble having a longer length is selected from the plurality of preambles as the target preamble. If the communication distance is small, a preamble having a shorter length is selected from the plurality of preambles as the target preamble. The UWB device uses any of the above strategies to select a target preamble with an appropriate length to balance multiple factors such as recognition accuracy, channel quality, and measurement duration in transceiving UWB signals.

In order to ensure timeliness of the status information, the UWB device can update the status information according to the status information of the detected preamble, so that the UWB device can determine the target preamble according to the updated status information, and the existing UWB device in the current environment can also replace the target preamble according to the updated status information, thereby improving the communication quality of the UWB device.

In some embodiments, the way of updating the status information may include periodic updates or updates based on being triggered by an event.

As an example, the UWB device may detect the status of a plurality of preset preambles every preset period, and update the status information according to the detection result.

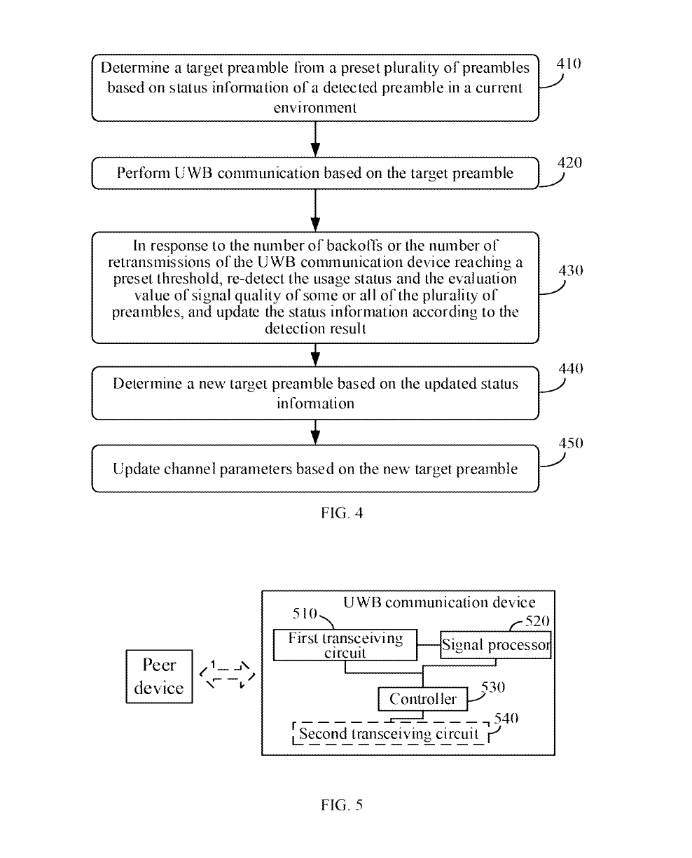

Or, periodic updates may be performed using the flow shown in FIG. 3. FIG. 3 shows a flowchart of periodically updating status information in one embodiment of the UWB communication method of the present disclosure, and as shown in FIG. 3, the flow includes the following steps.

Step 310: determining a preamble to be detected whose usage status is idle among the plurality of preambles based on the status information every preset period.

Step 320: detecting the usage status and signal quality of each preamble to be detected, and updating the status information according to the detection result.

The UWB device may mark the status of the preamble to be detected in the status information and record the signal quality of the preamble to be detected.

In order to reduce the time and resources consumed for detecting the preamble, the UWB device may only periodically detect the idle preamble in the current status information.

In some optional embodiments of this embodiment, when the status information is periodically updated, different periods may be set according to the type of the marked status information. For example, after the above step 320, the number of times each preamble is detected as idle may be recorded, and when the number of times any one or more preambles are detected to be idle reaches a preset number of times, the preset period may be extended.

In this embodiment, the more times a preamble is detected to be idle, the lower the frequency of use of the preamble. After the number of times that one or more of the current preambles are detected as idle reaches the preset number of times, the detection period can be extended, which is conducive to further reducing the resources consumed by periodic detection and ensure the accuracy of status information.

In another example of this embodiment, an update operation of the status information may also be triggered by an event. Herein, the event may come from monitoring of UWB communication operations by the UWB device, or an instruction issued by an upper application program to re-detect status information, etc. For example, a monitoring event of the UWB communication operation may include detecting that the number of backoffs or the number of retransmissions of the UWB communication operation reaches a preset threshold.

In practice, when a UWB device is interfered by other UWB devices, backoff or retransmission phenomena will occur. In this embodiment, the number of backoffs or the number of retransmissions may be used to characterize a degree to which the UWB device is interfered. When the number of backoffs or the number of retransmissions of the UWB communication operation of the UWB device reaches a preset threshold value, it indicates that the usage status of the preamble in the current environment has changed, resulting in a high degree to which the UWB device is interfered, and at this time, the status information can be updated by re-detection to obtain the latest status information of the preamble. Subsequently, a new target preamble can be determined according to the updated status information, and then the channel parameters of the UWB device and the peer device can be updated according to the new target preamble, so that the UWB device and the peer device can use better channel parameters to perform subsequent communication tasks.

Referring below to FIG. 4, FIG. 4 shows a flowchart of one embodiment of the UWB communication method of the present disclosure, and as shown in FIG. 4, the flow includes the following steps.

Step 410: determining a target preamble from a plurality of preset preambles based on the status information of the detected preamble in the current environment.

Step 420: performing UWB communication using the target preamble.

The steps 410 and 420 in this embodiment correspond to the steps 110 and 120 described above, and will not be repeated here.

Step 430: in response to the number of backoffs or the number of retransmissions of the target UWB device reaching a preset threshold, re-detecting the usage status and signal quality of some or all of the plurality of preambles, and updating the status information according to a detection result.

In some optional implementations of this embodiment, the idle preamble in the status information may be used as a detection object, a usage status of each idle preamble and a signal quality information corresponding to the detected occupied preamble may be detected, and the status information may be updated according to the detection result.

Since the probability of the idle preamble being interfered is lower than that of the occupied preamble, and the usage status of the occupied preamble usually does not change with addition of the new UWB device, when the usage status of the preamble is re-detected, the occupied preamble may not be detected, and only the idle preamble may be used as the detection object, thereby reducing the time and resources consumed by re-detection.

Step 440: determining a new target preamble based on the updated status information.

In this embodiment, the new target preamble may be re-determined based on the updated status information.

Step 450: updating channel parameters based on the new target preamble.

After determining the new target preamble, the UWB device shares channel parameters such as the new target preamble to the peer device, so that the UWB device and the peer device can adopt better channel parameters to perform subsequent communication tasks.

In this example, the status information can be updated according to the communication status of the target UWB device, and the target preamble and channel parameters of the target UWB device can be dynamically adjusted, thereby improving the communication quality of the target UWB device in an entire process of executing the communication task.

As shown in FIG. 5, an embodiment of the present disclosure further provides a UWB device including a first transceiving circuit 510 configured to transceive UWB signals for UWB communication and receive a UWB signal in a current environment for at least one period of time when the UWB communication is not performed; a signal processor 520 configured to be coupled to the first transceiving circuit 510 to detect status information of a preamble in the received UWB signal; a controller 530 configured to be coupled to the signal processor 520 and the first transceiving circuit 510 to control the first transceiving circuit 510 and the signal processor 520 to perform the UWB communication method in any of the above embodiments to perform UWB communication.

The UWB device in this embodiment may serve as an initiator or a responder of the UWB communication system, and may communicate with a peer device based on the UWB signal through the first transceiving circuit 510, thereby completing communication tasks such as ranging and positioning.

When a communication task is performed, under scheduling of the controller 530, the first transceiving circuit 510 may transceive UWB signals to interact with the peer device. In this process, the first transceiving circuit 510 may receive signals in the current environment during a certain period or multiple periods, and the received signals may be detected by the signal processor 520 (e.g., which may include synchronization header detection, signal quality detection, etc.) to determine the status information of the preamble in the UWB signal in the current environment. Then, the controller 530 determines the target preamble based on the status information, and the first transceiving circuit 510 transmits the target preamble to the peer device, thereby making an agreement that both parties communicate based on the target preamble. The probability that the target preamble is interfered can be reduced, thereby improving the communication quality.

As an example, the first transceiving circuit 510, the signal processor 520, and the controller 530 may be integrated in the form of circuitry on a UWB chip. The first transceiving circuit 510 is connected to the signal processor 520, and the signal processor 520 is connected to the controller 530. For example, the signal processor 520 is connected to the controller 530 through a temporary storage unit, the signal processor 520 writes detected information such as a signal strength and preambles into the temporary storage unit, so as to report the detected information to the controller. Optionally, the temporary storage unit includes one or more shifter registers which serve as buffers.

In some embodiments, the signal processor 520 is a logic circuit which is configured to perform calculation and logical processing on an input digital signal (sequence) and output calculation results. For example, the signal processor 520 may be a processor core, an Application-Specific Integrated Circuit (ASIC), or the like. The logical processing performed by the signal processor 520 include extracting signal features from the received digital signal, and the signal features may include preamble, RSSI, CIR, payload data, etc. Examples of the calculation include, but are not limited to: correlation calculations, average power calculations, and frequency offset estimation.

In some embodiments, the controller 530 is a logic circuit which is configured to perform logical processing on the calculation results output by signal processor 520. For example, the controller 530 may be a processor core, a memory, or the like. Examples of the logical processing performed by the controller 530 include at least one or more of the following: switching operating modes of the signal processor 520 and the first transceiving circuit 510, using the calculation results to select preambles that can be used during ranging interaction, extracting payload data and calculating distance, angle, etc.

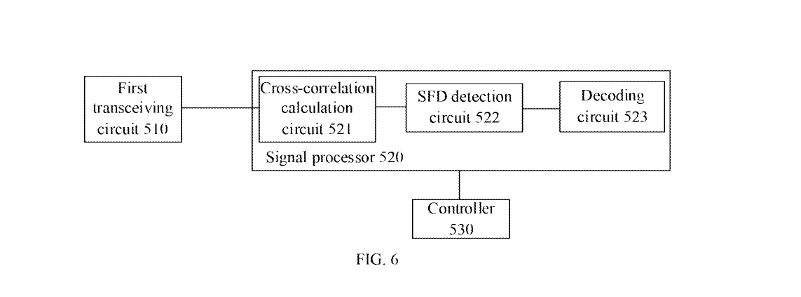

In some other embodiments, as shown in FIG. 6, the signal processor 520 includes a cross-correlation calculation circuit 521, an SFD (Start Frame Delimiter) detection circuit 522, a decoding circuit 523, etc.

The cross-correlation calculation circuit 521 is configured to receive the digital signal provided by the first transceiver circuit 510 and perform correlation calculation on the digital signal using at least one candidate preamble. The resulting calculation reflects the RSSI, correlation status, Channel Impulse Response (CIR), and frequency offset. The RSSI, correlation status, and CIR can be used to determine the occupied condition of the preamble in a non-ranging state; or to evaluate ranging success or failure in a ranging state. The non-ranging state indicates the first transceiver circuit 510 is in an idle state, for example the first transceiver circuit 510 is in low power state. The ranging state indicates the first transceiver circuit 510 is communicating to the peer device, or transceiving radar signals.

The frequency offset is caused by deviation of the local clock frequency from the initiator's clock frequency. In the ranging state, when correlation is detected, a periodicity characteristic of the received preamble is used to obtain the frequency offset relative to the local clock and recover the clock period of the opposite device.

In some embodiments, the cross-correlation calculation circuit 521 may include a signal strength indicator circuit and a synchronization circuit, but embodiments of the present application are not limited thereto, and other types of circuits may also be included in the cross-correlation calculation circuit 521.

Herein, the signal strength indicator circuit is configured to detect a strength of a UWB signal and transmit a detection result to the controller 530. For example, starting from a determined starting position of the preamble in the received digital signal, the signal strength indicator circuit extracts (e.g. by signal windowing) a signal segment with the length of the preamble from the digital signal, so as to calculate the energy of the signal segment to obtain the average power of the signal. In this way, the RSSI described above is obtained by the signal processor 520.

The synchronization circuit is configured to monitor status information of the preambles of the received UWB signal, and to transmit the status information to the controller 530. For example, the synchronization circuit may synchronize the preamble configured in advance in the UWB device (for example, it may be a correlation calculation) to monitor whether the preamble is occupied, obtain the status information of the preamble, and then report the status information of the preamble to the controller 530. For example, by using a sliding window, the synchronization circuit may perform correlation calculation on the candidate preamble. Whether the preamble in the received digital signal is correlated with the candidate preamble, as well as a starting position of a corresponding preamble in the received digital signal, can be determined from a result of the correlation calculation. The result of the correlation calculation can also be used in calculation of the CIR and the frequency offset.

In this example, the synchronization circuit may directly report the status information of the preamble obtained by monitoring to the controller 530, so that the UWB device can more quickly determine the target preamble according to the status information of the preamble, which is conducive to reducing the time consumed by the UWB device for configuring the target preamble.

The SFD detection circuit 522 is configured to detect a start frame delimiter subsequent to the preamble in the digital signal and record a corresponding reception timestamp. This reception timestamp is obtained by compensation based on the frequency offset.

The decoding circuit 523 is configured to decode payload data subsequent to the start frame delimiter. The payload data includes a physical layer frame header, (encrypted) data, etc.

In the non-ranging state, the cross-correlation calculation circuit 521 can obtain the calculation results corresponding to the candidate preambles through correlation operation and report them to the controller 530, and the SFD detection circuit 522 and the decoding circuit 523 can be in a low-power state. Thus, the cross-correlation calculation circuit 521 can improve the possibility of avoiding channel conflicts at the cost of short-term operation of the hardware circuit.

In the ranging state, the cross-correlation calculation circuit 521, the SFD detection circuit circuit 522, and the decoding circuit 523 are configured to use streaming transmission or block transmission using a buffer to perform signal analysis and clock adjustment, so as to adjust the clock and report the received timestamp, payload data, etc., to the MAC layer circuit (such as controller 530).

The controller 530 may configure one or more receiving circuits in the first transceiving circuit 510; and the signal processor 520 to transition between a first state and a second state, wherein when a receiving circuit and the signal processor 520 are in the first state (e.g., in the non-ranging state), the synchronization circuit monitors synchronization of preambles in a digital signal sequence provided by the receiving circuit to determine the occupied condition of the preambles in the current environment, and when an occupancy is detected or the monitoring is overtime, the synchronization circuit reports the occupied condition of each preamble monitored by the controller 530. When the corresponding receiving circuit and the signal processor 520 are in the second state (e.g., the ranging state), the synchronization circuit in the signal processor 520 synchronizes a local clock using the monitored preamble, and the decoding circuit or the like in the signal processor 520 decodes data packets using the local clock and reports the demodulated data.

Similarly, in the first state, the signal strength indicator circuit in the signal processor detects a signal-to-noise ratio or noise floor energy of the digital signal sequence provided by the receiving circuit to output a channel quality. In the second state, the channel quality output by the signal strength indicator circuit is used to assist in demodulating data or to evaluate confidence of the received digital signal sequence.

In some embodiments, in the first state, the first transceiving circuit 510 is powered, so that the signal processor 520 and the controller 530 filter the target preamble using any of the methods described above. In the second state, the first transceiving circuit 510 transmits UWB signals to send various channel parameters containing the target preamble; and the first transceiving circuit 510 receives a UWB signal from the peer device for UWB ranging interaction.

In some other embodiments, in the first state, the first transceiving circuit 510 is powered, so that the signal processor 520 and the controller 530 filter the target preamble using any of the methods described above. In the second state, the first transceiving circuit 510 still receives UWB signals in order for the signal processor 520 to monitor status information of preambles in the environment and also transmits UWB signals to send various channel parameters containing the target preamble. The second transceiving circuit 540 receives or transmits UWB signals from the peer device to achieve UWB ranging interaction.

In the non-ranging state, when preambles in the environment are to be monitored, the signal processor 520 and the controller 530 in the UWB chip trigger processing timing between circuits based on the detected preamble and its occupied condition, thereby implementing a hardware detection mechanism.

In the non-ranging state, in order to monitor the preambles in the environment, the first transceiving circuit 510 in the UWB chip converts the UWB signals into a digital signal. The signal processor 520 cyclically (or in parallel) reads each candidate preamble from the first buffer and performs correlation calculations on the received digital signal using each candidate preamble. The calculation results are then directly reported to the controller 530 using, for example, a second buffer. In this way, a hardware detection mechanism is implemented in the non-ranging state.

In the ranging state, the first transceiving circuit 510 in the UWB apparatus converts the received UWB signal into a digital signal. The signal processor 520 completely parses the digital signal according to different time slots of the ranging cycle clock. Examples of digital signal parsing methods include: parsing the preamble and decoding the payload data. The signal processor 520 uses the parsed preamble to determine the reception timestamp, among other operations. Examples of the payload data include UWB control information, such as ranging cycle index or ranging timestamp. Then, the signal processor 520 reports the payload data to the controller 530.

Compared to the non-ranging state, more circuit modules in the UWB apparatus are involved in signal processing in the ranging state. In different modes, the connection relationships between the various circuit modules in the UWB chip can be flexibly configured, resulting in changes in the data flow.

Embodiments of the present disclosure further provide a non-transitory computer storage medium, on which a computer program is stored, wherein the computer program, when executed by a processor enables the processor to schedule individual hardware circuits to perform the UWB communication method as in any of the above embodiments.

Those of ordinary skills in the art may understand that all or some of steps in the methods disclosed above, systems, functional modules or units in apparatuses may be implemented as software, firmware, hardware, and an appropriate combination thereof. In a hardware implementation, division of the function modules/units mentioned in the above description is not always corresponding to division of physical components. For example, a physical component may have multiple functions, or a function or a step may be executed by several physical components in cooperation. Some components or all components may be implemented as software executed by a processor such as a digital signal processor or a microprocessor, or implemented as hardware, or implemented as an integrated circuit such as a specific integrated circuit. Such software may be distributed on a computer-readable medium, and the computer-readable medium may include a computer storage medium (or a non-transitory medium) and a communication medium (or a transitory medium). As known to those of ordinary skills in the art, the “term computer storage medium” includes volatile or nonvolatile, and removable or irremovable media implemented in any method or technology for storing information (for example, a computer-readable instruction, a data structure, a program module, or other data). The computer storage medium includes, is but not limited to, a Random Access Memory (RAM), a Read-Only Memory (ROM), an Electrically Erasable Programmable ROM (EEPROM), a flash memory or other memory technologies, or other optical discs, a cassette, a magnetic tape, a disk memory or other magnetic storage apparatuses, or any other medium configurable to store expected information and accessible by a computer. In addition, it is known to those of ordinary skills in the art that the communication medium usually includes a computer-readable instruction, a data structure, a program module, or other data in a modulated data signal of, such as, a carrier or another transmission mechanism, and may include any information delivery medium.

1. A Ultra Wide Band (UWB) communication method applied to a UWB device comprising a transceiving circuit, a signal processor and a controller, the method comprising:
determining, by the signal processor, a target preamble from a plurality of preset preambles based on status information of detected preambles in a current environment; wherein the status information is configured to mark an occupied condition of each of the detected preambles; and
performing, by the transceiving circuit and the signal processor, UWB communication using the target preamble under control of the controller, to reduce a probability that the target preamble is interfered.

2. The method according to claim 1, wherein the plurality of preset preambles are all or part of preambles available for UWB ranging communication.

3. The method according to claim 1, wherein the performing the UWB communication using the target preamble comprises:
synchronizing, by the transceiving circuit, channel parameters comprising the target preamble to a peer device.

4. The method according to claim 1, wherein the status information is updated periodically or updated by the signal processor based on being triggered by an event.

5. The method according to claim 1, wherein the status information is set according to at least following information: whether a preamble is detected or signal quality of the detected preambles.

6. The method according to claim 4, wherein the periodic update comprises different periods set according to a type of marked status information.

7. The method according to claim 4, wherein an event triggering an update comprises detecting that a number of backoffs or retransmissions of UWB communication operation reaches a preset threshold.

8. The method according to claim 1, wherein the determining, by the signal processor, the target preamble from the plurality of preset preambles comprises determining, by the signal processor, the target preamble from the plurality of preset preambles using a priority of the status information.

9. The method according to claim 8, wherein the priority of the status information is set according to at least one of: channel idleness, signal quality, and communication distance.

10. A UWB device, comprising:
a first transceiving circuit configured to transceive UWB signals for UWB communication; and receive UWB signals in a current environment for at least one period of time when a UWB communication task is not performed;
a signal processor connected to the first transceiving circuit, and configured to detect status information of preambles in the UWB signals received; and
a controller connected to the signal processor and the first transceiving circuit, and configured to control the first transceiving circuit and the signal processor to perform the UWB communication method according to claim 1;
wherein power consumption of the UWB device for detecting the preambles is lower than power consumption of the UWB device for performing the UWB communication.

11. The UWB device according to claim 10, wherein the signal processor and the controller are configured to transmit data to each other through a temporary storage unit.

12. The UWB device according to claim 11, wherein in a first state,
the signal processor is configured to read, cyclically or in parallel, the candidate preambles from the temporary storage unit; and write a calculation result corresponding to each of the candidate preambles into the temporary storage unit;
wherein the calculation result is used for selecting preambles that are to be used in the UWB communication.

13. The UWB device according to claim 12, wherein in a second state,
the signal processor is configured to read a target preamble from the temporary storage unit, and write a calculation result obtained from the target preamble along with payload data into the temporary storage unit; wherein the target preamble is selected by the controller through evaluating the calculation result corresponding to each of the candidate preambles.

14. The UWB device according to claim 13, wherein the signal processor comprises a cross-correlation calculation circuit, a Start Frame Delimiter (SFD) detection circuit, and a decoding circuit;
the cross-correlation calculation circuit is configured to receive a digital signal which is obtained by converting a UWB signal by the first transceiver circuit and to perform signal processing on different signal segments of the digital signal to obtain the calculation result;
the SFD detection circuit is configured to detect a start frame delimiter subsequent in the digital signal and record a corresponding reception timestamp; and
the decoding circuit is configured to decode payload data subsequent in the digital signal.

15. The UWB device according to claim 14, wherein the first state is a non-ranging state, and at least one of the SFD detection circuit, and the decoding circuit is in a low-power mode in the non-ranging state.

16. The UWB device according to claim 14, wherein the cross-correlation calculation circuit comprises a signal strength indicator circuit and a synchronization circuit;
the signal strength indicator circuit is configured to detect a strength of the digital signal and transmit a detection result to the controller; and
the synchronization circuit is configured to monitor status information of the preamble of the received digital signal, and to transmit the status information to the controller.

17. The UWB device according to claim 13, wherein the first transceiving circuit is configured to synchronize channel parameters comprising the target preamble to a peer device; or
the UWB device further comprises a second transceiving circuit configured to be coupled to the controller to synchronize the channel parameters comprising the target preamble to the peer device.

18. The UWB device according to claim 17, wherein the first transceiver circuit is configured to receive a first UWB signal in the first state; or
the first transceiver circuit is configured to receive the first UWB signal or a second UWB signal in the second state;
wherein the first UWB signal is used by the signal processor to monitor the status information of the preamble; and the second UWB signal is used by the signal processor to analyze UWB ranging information.

19. A non-transitory computer storage medium, on which a computer program is stored, wherein the computer program, when executed by a controller, causes the controller to implement the UWB communication method according to claim 1.
